(19) United States
(12) Patent Application Publication
(10) Pub. No.: US 2011/0123143 A1
(43) Pub. Date: May 26, 2011

(54) RETAINER FOR ROLLER BEARING

(76) Inventors: Young-Keun LEE, Gyeongsangnam-do (KR); Cheol-Hwan Cha, Gyeongsangnam-do (KR)

(21) Appl. No.: 12/856,572

(22) Filed: Aug. 13, 2010

(30) Foreign Application Priority Data
Nov. 24, 2009 (KR) 10-2009-0113767
Apr. 23, 2010 (KR) 10-2010-0038066

(51) Int. Cl. F16C 33/48

(52) U.S. Cl. 384/572

(57) ABSTRACT

The present invention relates to a retainer for a roller bearing having any one or more of ring-like upper and lower rims and a plurality of bars connected at their ends to any one or more of the upper and lower rims in such a manner as to be circumferentially spaced apart from each other, the retainer including a chamfered face portion formed on each edge of both sides of each of the plurality of bars and having a plurality of first chamfered face sections adapted to be brought into direct contact with rollers and a plurality of second chamfered face sections formed more concaved than the plurality of first chamfered face sections.

### CROSS-REFERENCE TO RELATED APPLICATIONS

The present application claims priority under 35 U.S.C. 119 of Korean Patent Application No 10-2009-0113767, filed on Nov. 24, 2009, and Korean Patent Application No: 10-2010-0038066, filed on Apr. 23, 2010, the disclosures of which are expressly incorporated by reference herein, in their entirety.

### BACKGROUND OF THE INVENTION

1. Field of the Invention

The present invention relates to a retainer for a roller bearing, and more particularly, to a retainer for a roller bearing that is configured to reduce the area contacted with rollers thus to decrease the frictional force against the rollers, to guide the movement of lubricant thus to help the lubricant gently flow, to reduce all of the torque, vibration, abrasion and noise caused by the roller bearing thus to improve the performance of the roller bearing and thus to extend the life span thereof, and further to avoid the occurrence of the weakness of the strength thereof according to the reduction of the sectional areas of bars thus to prevent the load capability and the life span from being diminished.

2. Background of the Related Art

Bearings are largely classified into sliding bearings, ball bearings, and roller bearings. Among them, the roller bearings are widely used because they have relatively low rotational speeds and high supporting load and are available when substantially strong impacts are applied thereto. In accordance with the shapes of the roller bearings, they are sub-classified into cylindrical roller bearings, tapered roller'bearings, needle roller bearings and spherical roller bearings.

FIG. 1 is a sectional view showing a conventional tapered roller bearing; FIG. 2 is a perspective view showing a retainer for a tapered roller bearing according to one conventional practice, and FIG. 3 is a schematic sectional view taken along the line A-A of FIG. 2. For the description, two rollers are put into the retainer of FIG. 2.

As shown in FIG. 1, the tapered roller bearing 1 includes an inner race 10, an outer race 20, tapered rollers 30 and a retainer 50. The retainer 50 is disposed to allow the tapered rollers 30 to be circumferentially spaced apart from each other in the space between the inner race 10 and the outer race 20, while preventing the tapered rollers 30 from being contacted with each other.

As shown in FIGS. 2 and 3, the retainer 50 has a generally cup-like shape and includes a large-diametered upper rim 45, a small-diametered lower rim 55, a plurality of rectangular roller-receiving windows 75 circumferentially spaced, apart from each other in the space between the upper rim 45 and the lower rim 55, and a plurality of bars 65 disposed respectively between the adjacent roller-receiving windows 75. As a result, each of the roller-receiving windows 75 is defined by the combination of the upper rim 45, the lower rim 55 and the bars 65 formed at the both sides thereof. Thus, the rollers 30 are rotatably inserted into the rectangular-shaped roller-receiving windows 75 and are rollable in such a manner as to be spaced apart from each other. As shown, the roller-receiving windows 75 for the tapered roller bearing have a generally trapezoidal shape. At this time, each of the plurality of bars 65 has chamfered face portions 67 formed along the edges of the both sides, thereof, that is, along the inside edges toward the rollers 30, and the chamfered face portions 67 are formed inclinedly toward the center of the both sides thereof in such a manner as to be brought into contact with the rollers 30 and also to prevent the rollers 30 from being deviated toward the outside of the roller-receiving windows 75.

Each bar 65 having the chamfered face portions 67 has a sectional shape of a hexagon rounded at the inner and outer sides. The upper rim 45 and the lower rim 55 have a shape of a round ring.

The retainer 50 wherein the rollers 30 are received is disposed between the inside race 10 and the outside race 20 of the roller bearing 1. The roller bearing 1 is operated in a state of applying lubricant or grease thereto.

The rollers 30 rollably received in the retainer 50, according to the conventional practice, are contacted along the outer peripheral surfaces thereof with the chamfered face portions 67 of the bars 65 to cause substantially large contacted area with the chamfered face portions 67, which unfortunately makes the torque and vibration of the roller bearing substantially increased. As the rollers 30 are brought into contact with the chamfered face portions 67, the lubricant does not flow easily between the bars 65 and the rollers 30. In other words, when the space between the inner race 10 and the retainer 50 is defined as inside space and the space between the outer race 20 and the retainer as outer space, the lubricant does not flow gently from the inside space toward the outer space. Generally, the lubricant flowing into the outer space is discharged easily to the outside of the roller bearing 1, but the lubricant flowing into the inside space is not discharged easily by means of a large-sized projection 11 formed along the inner race 10 and stays therein. Accordingly, the torque of the roller bearing 1 is increased by the occurrence of the stirring resistance of the lubricant staying in the inside space.

Like this, the increase in the torque of the roller bearing 1 causes the roller bearing 1 used for the gentle rotation of mechanical members like a driving shaft to be deteriorated in the quality of performance thereof, and moreover, load may be excessively applied to the retainer 50 during the use of the roller bearing 1 to cause the retainer 50 to be broken, thereby shortening the average life span of the retainer 50.

FIG. 4 is a perspective view showing a retainer for a tapered roller bearing according to another conventional practice, so as to solve the above-mentioned conventional problems.

As shown in FIG. 4, there is provided a retainer 50′ for a tapered roller bearing having a plurality of bars 65′ increased partially in their circumferential width. In more detail, the retainer 50′ does not have any trapezoidal roller-receiving windows and linear bars and is provided with the bars 65′ each having a sectional area increased on a partial section in the middle portion thereof, such that only the partial sections of the bars 65′ are brought into contact with the rollers 30 to cause the contacted area between the rollers 30 and the bars 65′ to be substantially reduced, thereby allowing the torque of the roller bearing to be desirably decreased.

So as to maintain the strength of the bars 65, however, the bars 65′ of the retainer 50′ should be formed having the middle portions increased circumferentially in their width, while being not reduced in the their upper and lower widths in the circumferential direction thereof. Accordingly, the number of the bars 65′, that is, the number of a plurality of roller-receiving windows 75′ should be unavoidably decreased in order to make the bearings having the same sizes. Thus, the number of rollers 30 constituting the roller bearing is also reduced, which causes the load supported by the roller bearing to be decreased, and if die same load is applied to the roller bearing, the life span thereof becomes shortened.

Additionally, the roller-receiving windows 75′ of the retainer 50′ become complicated in their shape, and for example, so as to make the retainer 50′, after a metal plate is formed to a cup-like shape, the plurality of roller-receiving windows 75′ is formed thereon through shearing. In this case, actually, it is difficult to make the retainer 50′.

### SUMMARY OF THE INVENTION

Accordingly, the present invention has been made in view of the above-mentioned problems occurring in the prior art, and it is an object of the present invention to provide a retainer for a roller bearing that has a chamfered face portion formed inclinedly on the edges of both sides of each of bars with which rollers are contacted, the chamfered face portion having one or more first chamfered face sections and one or more second chamfered face sections having different protruding heights from each other, thereby minimizing the contacted area with the rollers without any increase and decrease of the circumferential width of the bars and allowing lubricant to gently flow.

It is another object of the present invention to provide a retainer for a roller bearing that has an inclined end portion formed at any, one or more of the upper and lower ends of each first chamfered face section in such a manner as to be inclined upwardly or downwardly from the outside to the inside along the direction of width of the chamfered face portion, thereby guiding lubricant from the inside to the outside and allowing the lubricant to gently flow.

It is still another object of the present invention to provide a retainer for a roller bearing that is capable of reducing the frictional force and heat generated between the rollers and the retainer thus to improve the performance of the roller bearing and to extend the life span of the roller bearing.

To accomplish the above objects, according to the present invention, there is provided a retainer for a roller bearing haying any one or more of ring-like upper and lower rims and a plurality of bars connected at their ends to any one or more of the upper and lower rims in such a manner as to be circumferentially spaced apart from each other, the retainer including a chamfered face portion formed on each, edge of both sides of each of the plurality of bars and, having a plurality of first chamfered face sections adapted to be brought into direct contact with rollers and a plurality of second chamfered face sections formed more concaved than the plurality of first chamfered face sections.

According to the present invention, desirably, the chamfered face portion includes at least one or more, first and second chamfered face sections formed thereon.

According to the present invention, desirably, the chamfered face portion further includes an inclined end portion formed at one or more positions wherein each of the first chamfered face sections and each of the second chamfered face sections face each other in such a manner as to be inclined upwardly or downwardly from the outside to the inside along the direction of width of the chamfered face portion.

According to the present invention, desirably, the first chamfered face sections are protruded to a predetermined curvature in at least one or more directions of the length and width of the chamfered face portion.

According to the present invention, desirably, the chamfered face portion includes an inclined end portion formed at any one or more of the upper and lower ends of the first chamfered face sections connected to the second chamfered face sections in such a manner as to be inclined upwardly or downwardly from the outside to the inside along the direction of width of the chamfered face portion.

According to the present invention, desirably, the second chamfered face sections have inclined angles larger than the first chamfered face sections with respect to the lines extended toward the widthwise centers of the plurality of bars from the central axis lines of the upper rim and the lower rim.

According to the present invention, desirably, each of the second chamfered face sections has inlet and outlet clearances formed between them and the rollers, the inlet clearance formed toward the inside thereof being larger than the outlet clearance formed toward the outside thereof.

### BRIEF DESCRIPTION. OF THE DRAWINGS

The above and other objects, features and advantages of the present invention will be apparent from the following detailed description of the preferred embodiments of the invention in conjunction with the accompanying drawings, in which:

FIG. 1 is a sectional view showing a conventional tapered roller bearing;

FIG. 2 is a perspective view showing a retainer for a tapered roller bearing according to one conventional practice;

FIG. 3 is a schematic sectional view taken along the line A-A of FIG. 2;

FIG. 4 is a perspective view showing a retainer for a tapered roller bearing according to another conventional practice;

FIG. 5 is a perspective view showing a retainer for a roller bearing according to the present invention;

FIGS. 6 and 7 are sectional views showing the chamfered face portions of the retainer for a roller bearing according to the present invention;

FIG. 8 is a sectional view showing another chamfered face portions of the retainer for a roller bearing according to the present invention;

FIGS. 9 and 10 are sectional views showing still another chamfered face portions of the retainer for a roller bearing according to the present invention;

FIG. 11 is a sectional view showing the semi-spherical chamfered face portions of the retainer for a roller bearing according to the present invention;

FIG. 12 is a sectional view showing the semi-cylindrical chamfered face portions of the retainer for a roller bearing according to the present invention;

FIG. 13 is a sectional view showing another semi-cylindrical chamfered face portions of the retainer for a roller bearing according to the present invention; and

FIG. 14 is a top sectional view showing the chamfered face portions of the retainer for a roller bearing according to the present invention.

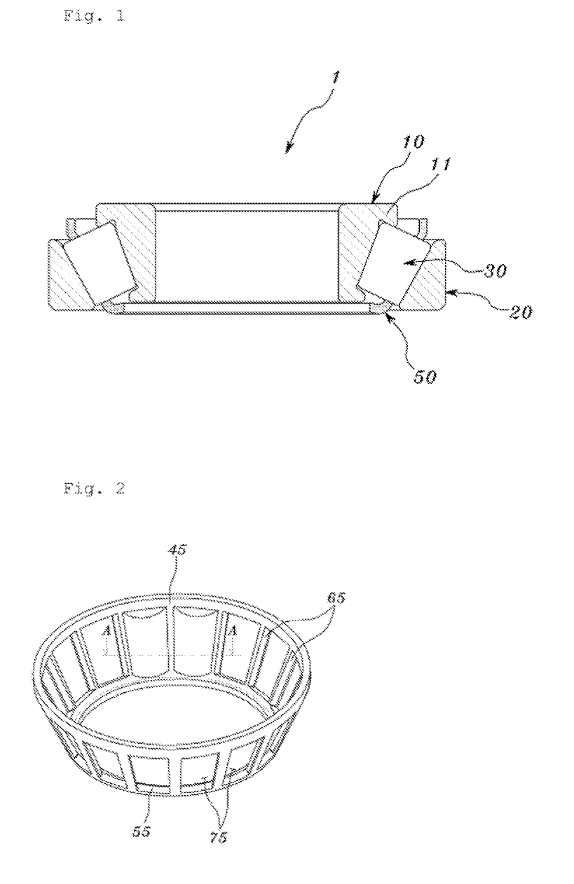

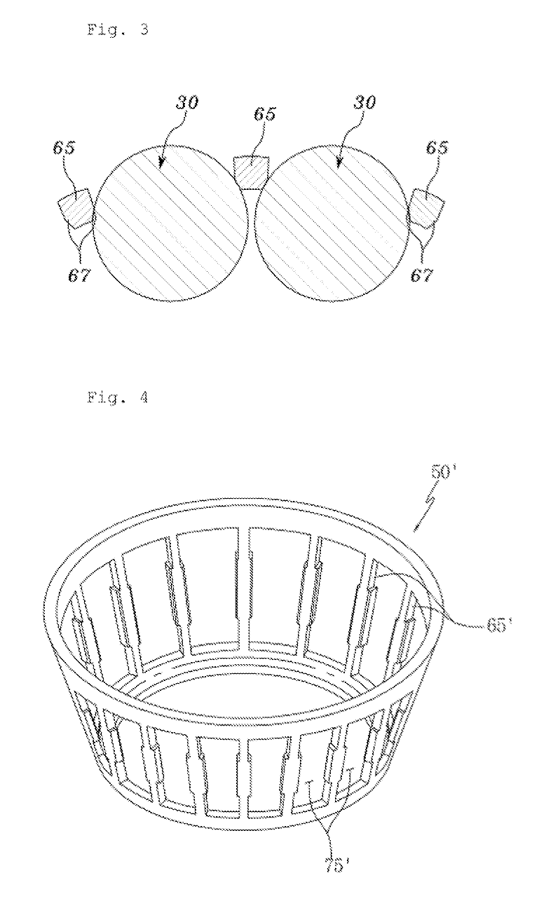

### DETAILED DESCRIPTION OF THE PREFERRED EMBODIMENT

Hereinafter, an explanation, on a retainer for a roller bearing according to the present invention will be in detail given with reference to the attached drawings.

The present invention is just suggested as examples without defining the appended claims, and the present invention can change or modify the embodiments without departing from the scope and spirit of the present invention.

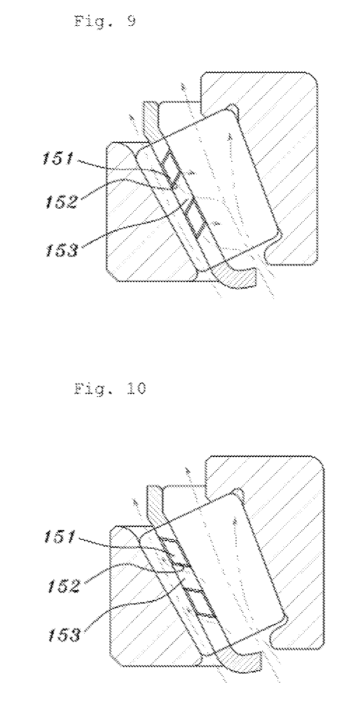

In the following description, the direction of I-I in FIG. 7 is defined as the width direction of a chamfered face portion, and the direction of II-II therein as the length direction thereof.

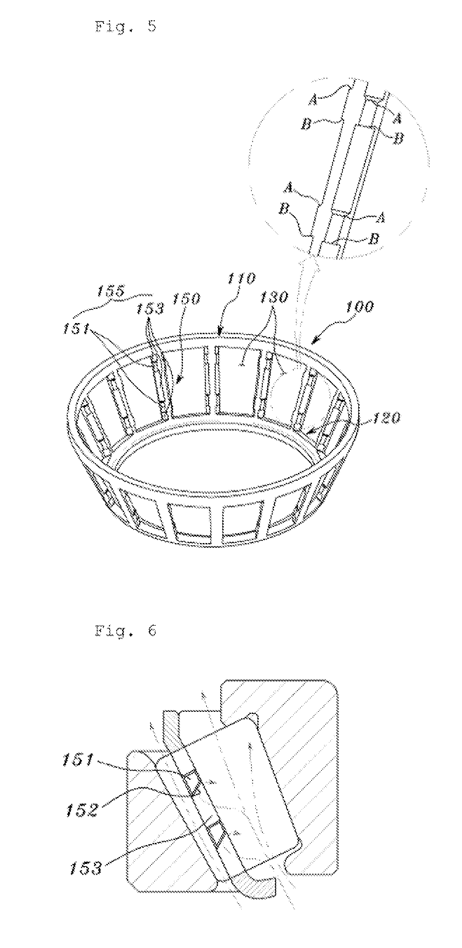

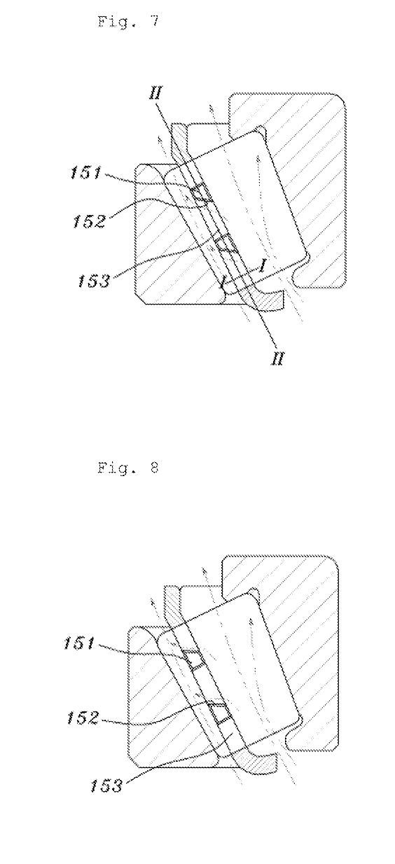

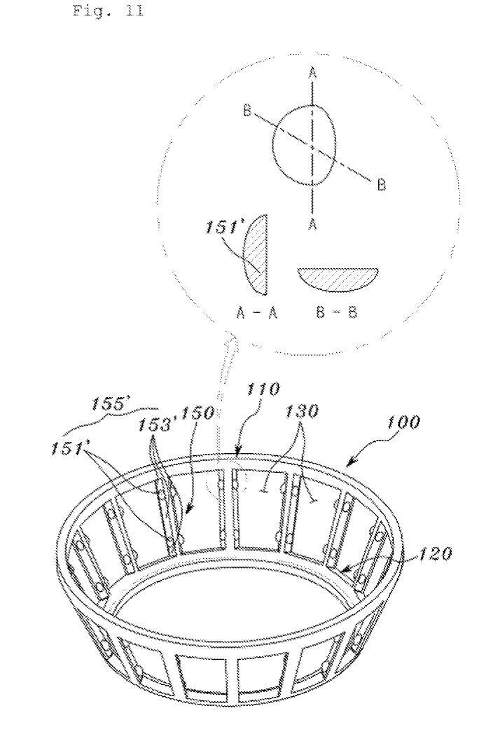

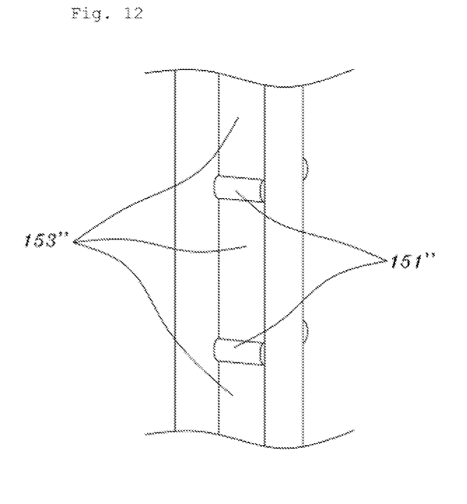

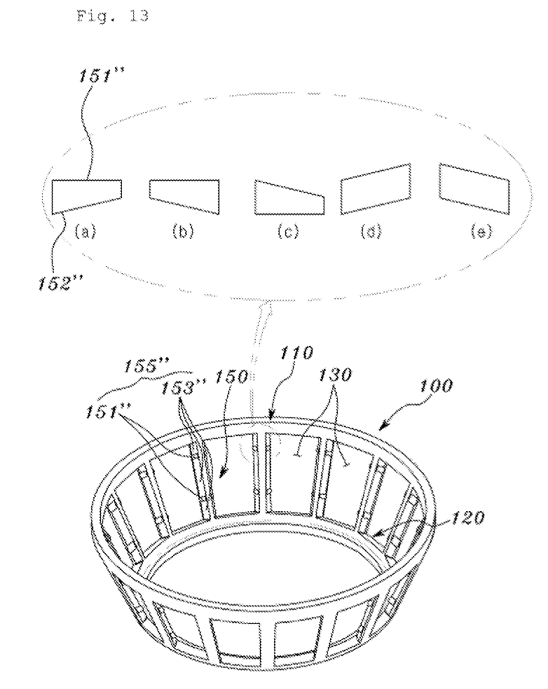

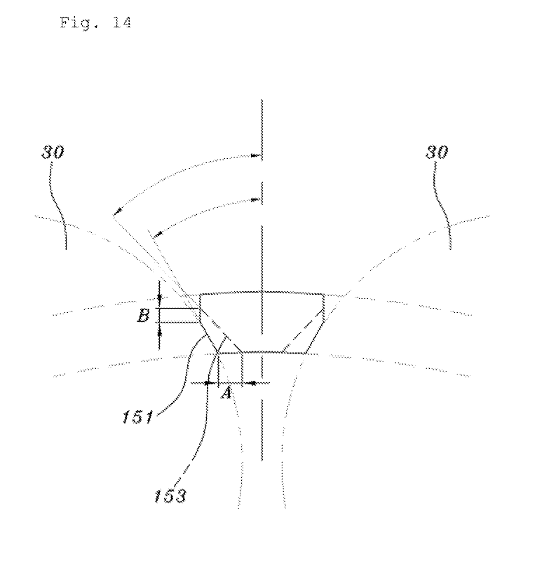

FIG. 5 is a perspective view showing a retainer for a roller bearing according to the present invention, FIGS. 6 and 7 are sectional views showing the chamfered face portions of the retainer for a roller bearing according to the present invention, FIG. 8 is a sectional, view showing another chamfered face portions of the retainer for a roller bearing according to the present invention, FIGS. 9 and 10 are sectional views showing still another chamfered face portions of the retainer for a roller bearing according to the present invention, FIG. 11 is a sectional view showing the semi-spherical chamfered face portions of the retainer for a roller bearing according to the present invention, FIG. 12 is a sectional view showing the semi-cylindrical chamfered face portions of the retainer for a roller bearing according to the present invention, FIG. 13 is a sectional view showing another semi-cylindrical chamfered face portions of the retainer for a roller bearing according to the present invention, and FIG. 14 is a top sectional view showing the chamfered face portions of the retainer for a roller bearing according to the present invention.

As shown in FIG. 5, a retainer 100 for a roller bearing largely includes an upper rim 110, a lower rim 120 and a plurality of bars 150. Of course, the retainer 100 for a roller bearing may include any one of the upper rim 110 and the lower rim 120 and the plurality of bars 150 connected at their one ends to any one of the upper rim 110 and the lower rim 120 and free at the other ends thereof.

The upper rim 110 and the lower rim 120 have a shape of a round ring to constitute the upper and lower portions of the retainer 100, and further, a plurality of roller-receiving windows 130 are circumferentially spaced apart from each other in the space between the upper rim 110 and the lower rim 120. The plurality of bars 150 is disposed respectively between the roller-receiving windows 130 to each other.

First, the roller-receiving windows 130 are of a generally rectangular shape and are circumferentially spaced apart from each other by a predetermined distance in the space between the upper rim 110 and the lower rim 120 in such a manner as to receive rollers 30 thereinto. In case of a tapered roller bearing, the roller-receiving windows 130 have a generally trapezoidal shape.

The plurality of bars 150 is connected to the upper rim 110 at the top ends thereof and to the lower rim 120 at the bottom ends thereof in such a manner as to be disposed respectively between the roller-receiving windows 130 adjacent to each other, thereby defining the roller-receiving windows 130 together with the upper rim 110 and the lower rim 120. The rollers 30 are received into the roller-receiving widows 130.

As shown in FIGS. 5 to 11, each of the plurality of bars 150 has a chamfered face portion 155 formed inclinedly on each edge of the both sides on which each roller 30 is placed, and the chamfered face portion 155 is brought into contact with the roller 30. The chamfered face portion 155 is formed on each inner edge of both sides of each bar 150 toward the roller 30. Of course, each bar 150 may have the section convexedly curved inwardly, and the chamfered face portions 155 of the bar 150 may be the portions rounded at the both sides curved inwardly.

Each of the chamfered face portions 155 includes first chamfered face sections 151 and second chamfered face, sections 153, and the first chamfered face sections 151 are protrudedly formed at predetermined positions of each chamfered face portion 155 in such a manner as to be directly contacted with the rollers 30. The second chamfered face sections 153 are formed more concaved than the first chamfered face sections 151 in such a manner as to be spaced apart from the rollers 30 to form clearances between the roller 30 and them.

At this time, at least one or more first chamfered face sections 151 are formed at one of the chamfered face portions 155 disposed at the both sides of each bar 150, and also, at least one or more first chamfered face sections 151 are formed at the other chamfered face portions 155.

FIG. 5 shows an embodiment wherein the first chamfered face sections 151 formed at the chamfered face portions 155 formed on the both sides of each bar 150 have the same positions as each other, but of course, they may be formed in different positions from each other on the both sides of each bar 150.

At this time, the first chamfered face sections 151 and the second chamfered face sections 153 have continual or discontinuous steps thereon, and any one or more of the upper and lower ends of each of the first chamfered face sections 151 have an inclined end portion 152 inclined upwardly or downwardly from the outside to the inside along the direction of width of the chamfered face portion 155. As shown in an enlarged portion of FIG. 5, of course, the upper ends A and the lower ends B of the first chamfered face sections 151 may be formed without any inclination.

The inclined directions of the inclined end portion 152 can be adjusted in accordance with the applied part thereof, the available environment, and the requirements (for example, torque, lubrication, and so on). The examples of the inclined directions of the inclined end portion 152 will be explained with reference to FIGS. 6 to 10.

As shown in FIG. 6, first, two or more first chamfered face sections 151 are formed, and the second chamfered face sections 153 are formed respectively between the first chamfered face sections 151 and at the upper and lower sides of the first chamfered face sections 151. The second chamfered face section 153 may be formed only between the first chamfered face sections 151.

The inclined end portion 152 is formed along the lower end of each first chamfered face section 151 in such a manner as to be inclined upwardly or downwardly from the outside to the inside, along the direction of width of the chamfered face portion 155.

FIG. 6 shows the inclined end portion 152 inclined upwardly, wherein when the lubricant is supplied to the inside and outside of the lower rim 120, the lubricant flowing to the inside of the lower rim 120 partially flows outwardly by a centrifugal force and is thus guided to flow toward the inside again by means of the inclined end portion 152, thereby gently flowing to the inside of the retainer 100.

On the other hand, FIG. 7 shows the inclined end portion 152 inclined downwardly, wherein when the lubricant is supplied to the inside and outside of the lower rim 120, the lubricant flowing to the inside of the lower rim 120 partially flows outwardly by a centrifugal force and is thus guided to flow toward the outside by means, of the inclined end portion 152, thereby gently flowing to the outside of the retainer 100.

The upward and downward inclinations of the inclined end portion 152 are determined differently in accordance with the viscosity of the lubricant, and for example, if the lubricant has similar viscosity to desirably, the inclined end portion 152 is inclined downwardly from the outside to the inside along the direction of width of the chamfered face portion 155.

The lubricant having the similar viscosity to oil is rapidly passed through the rollers 30, the inner race 10 and the outer race 20, without any staying at the inside of the retainer 100, thereby reducing friction force and heat. Thus, the lubricant is guided to the outside of the retainer 100.

If the lubricant has similar viscosity to grease, on the other hand, desirably, the inclined end portion 152 is inclined upwardly, from the outside to the inside along the direction of width of the chamfered face portion 155. Since the lubricant having similar viscosity to grease should flow actively at the inside of the retainer 100, when compared with the lubricant having similar viscosity to oil rapidly-passed through the rollers 30, the inner race 10 and the outer race 20, the lubricant is guided to the space between the rollers 30 and the inner race 10 and to flow therebetween.

As shown in FIG. 8, further, two or more first chamfered face sections 151 are formed, and the second chamfered face sections 153, are formed respectively between the first chamfered face sections 151 and at the upper and lower sides of the first chamfered face sections 151. The second chamfered face section 153 may be formed only between the first chamfered face sections 151.

The inclined end portion 152 is formed along the upper end of each first chamfered face section 151 in such a manner as to be inclined downwardly from the outside to the inside along the direction of width of the chamfered face portion 155. The inclined end portion 152 is inclined downwardly wherein when the lubricant is supplied to the inside and outside of the lower rim 120, the lubricant flowing to the inside of the lower rim 120 partially flows outwardly and is thus guided to flow toward the outside again by means of the inclined end portion 152, thereby gently flowing to the outside of the retainer 100.

On the other hand, two or more first chamfered face sections 151 are formed, and the second chamfered face sections 153 are formed respectively between the first chamfered face sections 151 and at the upper and lower sides of the first chamfered face sections 151. The second chamfered face section 153 may be formed only between the first chamfered face sections 151. The inclined end portion 152 is formed along the upper and lower ends of each first chamfered face section 151, respectively, in such a manner as to be inclined upwardly or downwardly from the outside to the inside along the direction of width of the chamfered face portion 155.

As shown in FIG. 9, first, the inclined end portion 152 formed along the upper end of each first chamfered face section 151 is inclined upwardly from the outside to the inside along the direction of width of the chamfered face portion 155, and the inclined end portion 152 formed along the lower end of each first chamfered face section 151 is inclined upwardly from the outside to the inside along the direction of width of the chamfered face portion 155.

As a result, when the lubricant is supplied to the inside and outside of the lower rim 120, the lubricant flowing to the inside of the lower rim 120 partially flows outwardly and is thus guided to flow toward the inside again by means of the inclined end portion 152 formed along the lower end of each first chamfered face section 151, thereby gently flowing to the inside of the retainer 100.

As shown in FIG. 10, next, the inclined end portion 152 formed along the upper end of each first chamfered face section 151 is inclined downwardly from the outside, to the inside along the direction of width of the chamfered face portion 155, and the inclined end portion 152 formed along the lower end of each first chamfered face section 151 is inclined downwardly from the outside to the inside along the direction of width of the chamfered face portion 155.

As a result, when the lubricant is supplied to the inside and outside of the lower rim 120, the lubricant flowing to the inside of the lower rim 120 partially flows outwardly by a centrifugal force and is thus, guided to flow toward the outside by means, of the inclined end portions 152 formed along the upper and lower ends of each first chamfered face section 151, thereby gently flowing to the outside, of the retainer 100 and preventing staying at the inside of the retainer 100.

As shown in FIG. 11, on the other hand, there is proposed another example of the chamfered face portion 150 wherein first chamfered face sections 151′ are formed protrudedly to a predetermined curvature along the directions of length and width of each chamfered face portion 155 in such a manner as to be brought into contact with the rollers 30 at, the center portions thereof. At this time, two or more first chamfered face sections 151′ are formed, and second chamfered face sections 153′ are formed respectively between the first chamfered face sections 151′ and at the upper and lower sides of the first chamfered face sections 151′.

Each of the first chamfered face sections 151′ is formed of a generally semispherical shape, such that the sectional shape of A-A and that of B-B are the same as each other. Of course, the first chamfered face sections 151′ may have a generally semioval shape. Like this, the first chamfered face sections 151′ having a semispherical or semioval shape are brought into point-contact with the rollers 30, thereby substantially reducing the frictional force therebetween and increasing the areas of the second chamfered face sections 153′ through which the lubricant flows to allow the torque and vibration caused by the roller bearing to be greatly diminished.

As shown in FIGS. 12 and 13, furthermore, there is proposed still another example of the chamfered face portion 150 wherein first chamfered face sections 151″ are extended protrudedly to the direction of width of the chamfered face portion 150 with a predetermined curvature along the direction of length of the chamfered face portion 155 in such a manner as to be brought into contact with the rollers 30. At this time two or more first chamfered face sections 151″ are formed, and second chamfered face sections 153″ are formed respectively between the first chamfered face sections 151″ and at the upper and lower sides of the first chamfered face sections 151″. Of course, the second chamfered face section 153″ may be formed only between the first chamfered face sections 151″.

As shown in FIG. 12, the first chamfered face sections 151″ are formed of a generally semicylindrical shape, and thus, they are brought into contact with the rollers 30, thereby substantially reducing the frictional force therebetween and also diminishing the torque and vibration caused by the roller bearing.

As shown in FIG. 13, each of the first chamfered face sections 151″ has an inclined end portion 152″ formed at any one or more of the upper and lower ends connected to each of the second chamfered face sections 153″. The upper part from the most protruded portion of the semicylindrical first chamfered face section 151″ is defined as the upper end, and the lower part therefrom as the lower end.

The inclined end portion 152″ is inclined upwardly or downwardly from the outside to the inside along the direction of width of the chamfered face portion 155.

In case of the first chamfered face section 151″ having a shape (a), the inclined end portion 152″ is formed at the lower end of the first chamfered face section 151″ in such a manner as to be inclined upwardly from the outside to the inside along the direction of width of the chamfered face portion 155. As a result, when the lubricant is supplied to the inside and outside of the lower rim 120, the lubricant flowing to the inside of the lower rim 120 partially flows outwardly by a centrifugal force and is thus guided to flow toward the inside again by means of the inclined end portion 152″, thereby gently flowing to the inside of the retainer 100.

In case of the first chamfered face section 151″ having a shape (b), the inclined end portion 152″ is formed at the lower end of the first chamfered face section 151″ in such a manner as to be inclined downwardly from the outside to the inside along the direction of width of the chamfered face portion 155. As a result, when the lubricant is supplied to the inside and outside of the lower rim 120, the lubricant flowing to the inside of the lower rim 120 partially flows outwardly and is thus guided to flow toward the outside by means of the inclined end portion 152″, thereby gently flowing to the outside of the retainer 100.

In case of the first chamfered face section 151″ having a shape (c), the inclined end portion 152″ is, formed at the upper end of the first chamfered face section 151″ in such a manner as to be inclined downwardly from the outside to the inside along the direction of width of the chamfered face portion 155. As a result, the lubricant flowing, to the inside of the lower rim 120 partially flows and is, guided toward the outside by means of the inclined end portion 152″, thereby gently flowing to the outside of the retainer 100.

In case of the first chamfered face section 151″ having a shape (d), the inclined end portion 152″ is formed at the upper and lower ends of the first chamfered face section 151″, respectively, in such a manner as to be inclined upwardly from the outside to the inside along the direction of width of the chamfered face portion 155. As a result, when the lubricant is supplied to the inside and outside of the lower rim 120, the lubricant flowing to the inside of the lower rim 120 partially flows outwardly by a centrifugal force and is thus guided to flow toward the inside again by means of the inclined end portions 152″, thereby gently flowing to the inside of the retainer 100.

In case of the first chamfered face section 151″ having a shape (e), the inclined end portion 152″ is formed at the upper and lower ends of the first chamfered face section 151″, respectively, in such a manner as to be inclined downwardly from the outside to the inside along the direction of width of the chamfered face portion 155. As a result, when the lubricant is supplied to the inside and outside of the lower rim 120, the lubricant flowing to the inside, of the lower rim 120 partially flows outwardly by a centrifugal force and is thus guided to flow toward the outside by means of the inclined end portions 152″, thereby gently flowing to the outside of the retainer 100.

The inclined directions of the inclined end portion 152″ are determined differently in accordance with the viscosity of the lubricant, and if the lubricant has similar viscosity to grease, desirably, the inclined end portion 152″ is inclined upwardly such that the lubricant flowing to the inside is guided again toward the inside, thereby gently flowing to the inside of the retainer 100. Contrarily, if the lubricant has similar viscosity to oil, desirably, the inclined end portion 152″ is inclined downwardly such that the lubricant flowing to the inside is guided toward the outside, thereby gently flowing to the outside of the retainer 100.

As shown in FIG. 14, on the other hand, the second, chamfered face section 153 has a different inclined angle from the first chamfered face section 151. In more detail, the second chamfered face section 153 has the inclined angle larger than the first chamfered face section 151 with respect to the lines extended toward the widthwise centers of the plurality of bars 150 from the central axis lines of the upper rim 110 and the lower rim 120.

As a result, the flowing passageway of the lubricant is ensured to diminish the frictional force and heat between the rollers 30 and the retainer 100, which allows the torque and vibration of the roller bearing to be substantially reduced.

The retainer 100 is mounted to the roller bearing, and when the rollers 30 are disposed between the bars 150 and the roller bearing is operated, the lubricant partially flows from the inside to the outside through clearances formed between the second chamfered face sections 153 and the rollers 30. When the lubricant flows from the inside to the outside, as shown in FIG. 14, the second chamfered face section 153 is desirably formed wherein an inlet clearance A formed toward the inside thereof is formed larger than an outlet clearance B formed toward the outside thereof. That is, the second chamfered face section 153 is desirably formed wherein the maximum distance between the second chamfered face section 153 and the first chamfered face section 151 at the inside thereof is longer than the maximum distance between them at the most outside thereof. The formation of the clearance toward the outside as described above means the opening toward the outside space. This includes the vertical orientation toward the outside and anything having components toward the outside. In the same manner as above, the formation of the clearance toward the inside as described above means the opening toward the inside space.

Under the formation of the second chamfered face section 153 as described above, when the lubricant flows to the inlet clearance A at the inside of the second chamfered face section 153 and then flows to the outside thereof through the outlet clearance B, a predetermined pressure is formed between the second chamfered face section 153 and the rollers 30, and an external force is made on the rollers 30 in a direction distant from the second chamfered face section 153. Accordingly, the direction contact between the rollers 30 and the first chamfered face section 151 can be minimized and further avoided, thereby permitting the frictional force caused between the rollers 30 and the retainer 100 to be greatly reduced.

FIG. 14 shows the second chamfered face section 153 having a linear surface, but it may have a concavedly curved surface or a variety of surfaces.

As mentioned above, the retainer for a roller bearing according to the present invention does not need the increase in the circumferential widths of the bars defining the roller-receiving windows, that is, the sectional areas of the bars, thereby preventing the reduction of the number of rollers when the roller bearing is made, while still maintaining the strength of the bars, reducing the frictional force between the bars and the rollers through the decrease in the contact area therebetween, allowing the lubricant to gently flow to reduce the frictional force of the rollers, diminishing the torque and vibration of the roller bearing and the abrasion and noise caused therefrom, and providing the improvement in the performance of the roller bearing and the extension of the life span thereof.

While the present invention has been described with reference to the particular illustrative embodiments, it is not, to be restricted by the embodiments but only by the appended claims. It is to be appreciated that those skilled in the art can change or modify the embodiments without departing from the scope and spirit of the present invention.

What is claimed is:

1. A retainer for a roller bearing having any one or more of ring-like upper and lower rims and a plurality of bars connected at their ends to any one or more of the upper and lower rims in such a manner as to be circumferentially spaced apart from each other, the retainer comprising a chamfered face portion formed on each edge of both sides of each of the plurality of bars and having a plurality of first chamfered face sections adapted to be brought into direct contact with rollers and a plurality of second chamfered face sections formed more concaved than the plurality of first chamfered face sections.

2. The retainer for a roller bearing according to claim 1, wherein the chamfered face portion comprises at least one or more first and second chamfered face sections formed thereon.

3. The retainer for a roller bearing according to claim 1, wherein the chamfered face portion further comprises an inclined end portion formed at one or more positions wherein each of the first chamfered face sections and each of the second chamfered face sections face each other in such a manner as to be inclined upwardly or downwardly from the outside to the inside along the direction of width of the chamfered face portion.

4. The retainer for a roller bearing according to claim 1, wherein the first chamfered face sections are protruded to a predetermined curvature in at least one or more directions of the length and width of the chamfered face portion.

5. The retainer for a roller bearing according to claim 4, wherein the chamfered face portion comprises an inclined end portion formed at any one or more of the upper and lower ends of the first chamfered face sections connected to the second chamfered face sections in such a manner as to be inclined upwardly or downwardly from the outside to the inside along the direction of width of the chamfered face portion.

6. The retainer for a roller bearing according to claim 1, wherein the second chamfered face sections have inclined angles larger than the first chamfered face sections with respect to the lines extended toward the widthwise centers of the plurality of bars from the central axis lines of the upper rim and the lower rim.

7. The retainer for a roller bearing according to claim 1, wherein each of the second chamfered face sections has inlet, and outlet clearances formed between them and the rollers, the inlet clearance formed toward the inside thereof being larger than the outlet clearance formed toward the outside thereof.
